(19) United States
(12) Patent Application Publication
(10) Pub. No.: US 2026/0192903 A1
(43) Pub. Date: Jul. 9, 2026

(54) BIONIC SAILFISH

(71) Applicant: Muqing YU, Beijing (CN)

(72) Inventors: Muqing YU, Beijing (CN); Cen ZENG, Dalian City (CN); Jinyi CHU, Dalian City (CN); Yang CAO, Dalian City (CN); Yuqi XIE, Dalian City (CN); Shengbo ZHAO, Dalian City (CN); Xinyu WANG, Dalian City (CN); Guangpu PEI, Dalian City (CN); Hua PAN, Dalian City (CN); Guodong ZHANG, Dalian City (CN)

(21) Appl. No.: 19/050,311

(22) Filed: Feb. 11, 2025

(30) Foreign Application Priority Data
Jan. 6, 2025 (CN) 202510014357.3

(51) Int. Cl. B63G 8/00; G05D 1/46; G05D 105/80; G05D 109/30

(52) U.S. Cl. CPC B63G 8/001; G05D 1/46; B63G 2008/004; B63G 2008/005; G05D 2105/87; G05D 2109/38

(57) ABSTRACT

A bionic sailfish, includes a fish body, pectoral fins, a caudal fin and a control module. Pectoral fin steering engines are mounted at both sides of an interior of the fish body. Rotation axes of output ends of the pectoral fin steering engines extend along both sides of the fish body. The pectoral fins are arranged on the both sides of the fish body and fixed to the output ends of the pectoral fin steering engines. The longitudinal sections at any positions in the pectoral fins are parallel to a longitudinal central plane of the fish body. The caudal fin is arranged at a tail end of the fish body and connected to the fish body through a caudal fin steering engine. The control module is arranged at the interior of the fish body and electrically connected to the pectoral fin steering engines and the steering engine.

### CROSS-REFERENCE TO RELATED APPLICATION

This patent application claims the benefit and priority of Chinese Patent Application No. 202510014357.3 filed with the China National Intellectual Property Administration on Jan. 6, 2025, the disclosure of which is incorporated by reference herein in its entirety as part of the present application.

### TECHNICAL FIELD

The present disclosure relates to the field of bionic detection technologies, and in particular to a bionic sailfish.

### BACKGROUND

With continuous exploitation and utilization of marine resources by human beings, nowadays, an autonomous underwater robot has become an important tool for human beings to conduct marine research and exploration. In recent years, with continuous exploration of human's understanding of fish swimming mechanisms and development of related manufacturing technologies and control technologies, an underwater vehicle using a bionic fish-body propulsion mechanism has emerged, providing a new idea for developing an efficient, high-mobility, low-noise and easily concealable underwater vehicle.

A bionic fish is an underwater vehicle propelled by using the fish swimming mechanisms and equipped with various micro-sensors, and a set of swimming detector similar to a fish-body structure can be constructed by using advanced control and communication means. However, a traditional bionic fish usually uses a traditional submarine-type tank snorkeling system. Although the tank snorkeling system is flexible in adjustment and can effectively control floating and diving of the bionic fish, it takes up a large volume, which imperceptibly increases the size of the bionic fish, not only leading to greater resistance to running of the bionic fish in water but also adversely affecting its mobility, concealability and passability in narrow areas.

Therefore, it is necessary to develop a new bionic fish to solve the above technical problems.

### SUMMARY

An objective of the present disclosure is to provide a bionic sailfish to solve problems in the conventional technology.

In order to achieve the above objective, the present disclosure provides the following solutions.

A bionic sailfish, including a fish body, pectoral fins, a caudal fin and a control module. Pectoral fin steering engines are mounted on both sides of an interior of the fish body, and rotation axes of output ends of the pectoral fin steering engines extend along both sides of the fish body. The pectoral fins are arranged on the both sides of the fish body and fixedly connected to the output ends of the pectoral fin steering engines. Longitudinal sections of the pectoral fins are spindle-shaped, and the longitudinal sections at any positions in the pectoral fins are parallel to a longitudinal central plane of the fish body. The caudal fin is arranged at a tail end of the fish body and connected to the fish body through a caudal fin steering engine. The control module is arranged at the interior of the fish body and electrically connected to the pectoral fin steering engines and the caudal fin steering engine.

Preferably, front edges of the pectoral fins are tilted backwards.

Preferably, the bionic sailfish further includes a caudal peduncle connected between the caudal fin and the fish body, the caudal peduncle is connected to the fish body and the caudal fin through a caudal peduncle steering engine and the caudal fin steering engine, respectively.

Preferably, a back of the fish body is provided with a dorsal fin.

Preferably, the back of the fish body is provided with a wireless signal communication module electrically connected to the control module, the wireless signal communication module is arranged behind the dorsal fin.

Preferably the fish body includes an upper housing and a lower housing connected through bolts, a keel being connected to the upper housing through bolts, and the control module is mounted above the keel.

Preferably, a camera module is mounted at a bottom of a front end of the keel, the camera module is located in the lower housing, and the lower housing is provided with a transparent window for the camera module to photograph therethrough.

Preferably, a storage battery is further mounted below the keel.

Preferably, a gyroscope is mounted at a front end of the keel, and is electrically connected to the control module.

Preferably, a front end of the fish body is provided with a conical fish mouth.

Preferably, the fish mouth is connected to the fish body through a thread.

Compared with the conventional technology, the present disclosure has the following technical effects.

In the present disclosure, the pectoral fins are connected to the pectoral fin steering engines, and the pectoral fin steering engines can rotate to drive front ends of the pectoral fins to swing upwards or downwards, so as to realize rising or diving, thereby a tank snorkeling system is omitted, the size of the bionic sailfish is greatly reduced, the running resistance of the bionic sailfish in water is less, and the movement is more flexible.

### BRIEF DESCRIPTION OF THE DRAWINGS

In order to illustrate the technical solutions in the embodiments of the present disclosure or in the conventional technology more clearly, a brief introduction to the drawings required for the embodiments will be provided below. Obviously, the drawings in the following description are merely some of the embodiments of the present disclosure, and those of ordinary skill in the art can also obtain other drawings according to these drawings without involving any inventive effort.

FIG. 1 is a schematic structural diagram of a bionic sailfish according to an embodiment of the present disclosure;

FIG. 2 is a side view of FIG. 1;

FIG. 3 is a schematic structural diagram of an upper housing according to an embodiment;

FIG. 4 is a schematic structural diagram of a lower housing according to an embodiment;

FIG. 5 is a schematic diagram of an assembly structure of all electrical elements on a keel according to an embodiment; and

FIG. 6 is a schematic structural diagram of the keel.

### LIST OF REFERENCE SIGNS

1. Fish body; 2. Pectoral fin; 3. Caudal fin; 4. Control module; 5. Pectoral fin steering engine; 6. Caudal peduncle; 7. Dorsal fin; 8. Caudal fin steering engine; 9. Caudal peduncle steering engine; 10. Upper housing; 11. Lower housing; 12. Keel; 13. Camera; 14. Gyroscope; 15. Storage battery; 16. Fish mouth; 17. Connecting rod; 18. Supporting plate; 19. Communication module.

### DETAILED DESCRIPTION OF THE EMBODIMENTS

The technical solutions in the embodiments of the present disclosure will be clearly and completely described below in conjunction with the accompanying drawings in the embodiments of the present disclosure. Apparently, the embodiments described are merely some rather than all of the embodiments of the present disclosure. On the basis of the embodiments of the present disclosure, all other embodiments obtained by those of ordinary skill in the art without involving any inventive effort fall within the scope of protection of the present disclosure.

An objective of the present disclosure is to provide a bionic sailfish to solve problems in the conventional technology.

In order to make the objectives, features and advantages of the present disclosure more clearly understood, the present disclosure will be further described in detail below with reference to the accompanying drawings and specific embodiments.

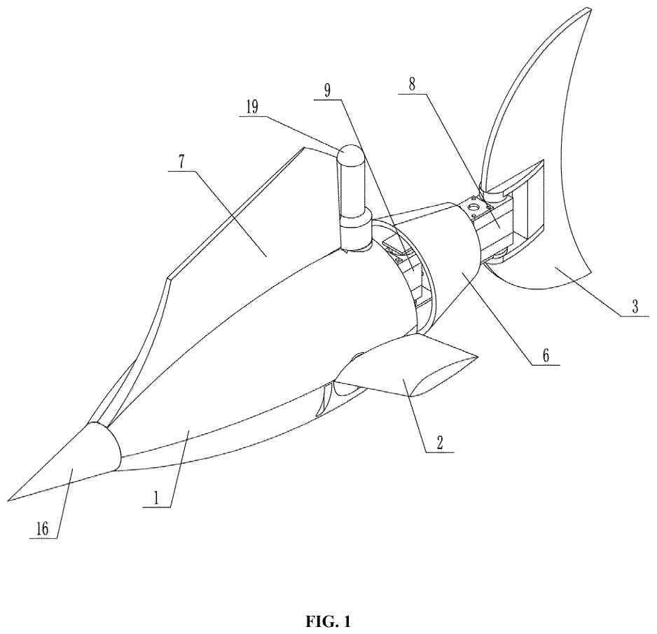

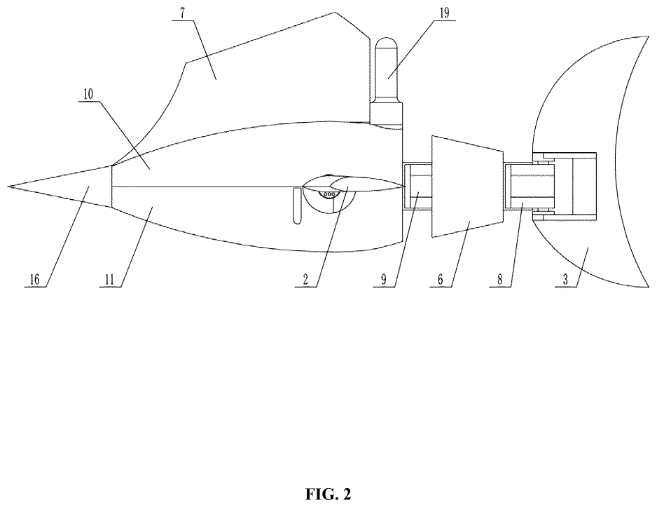

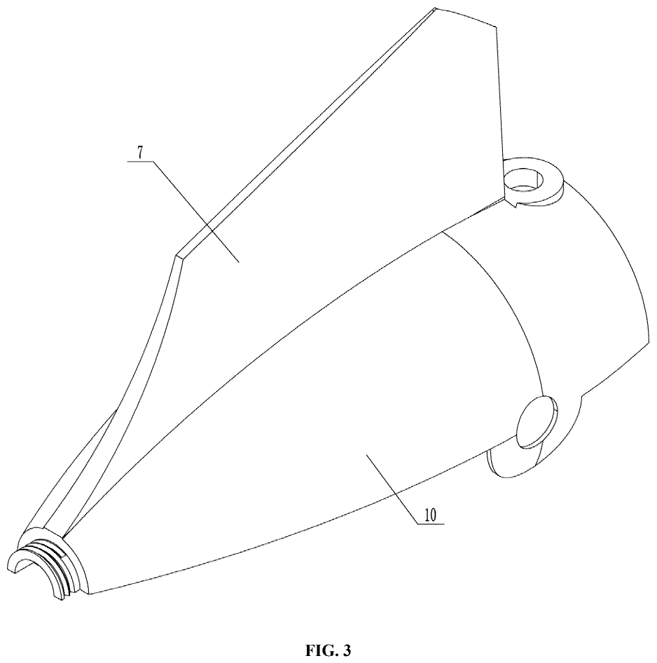

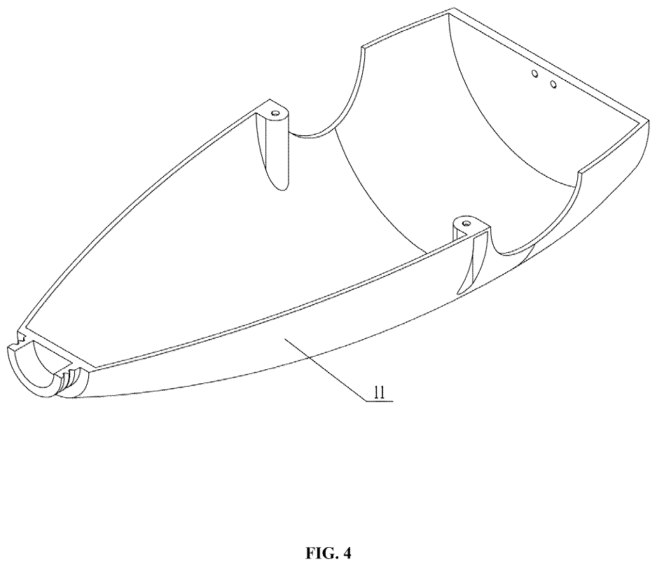

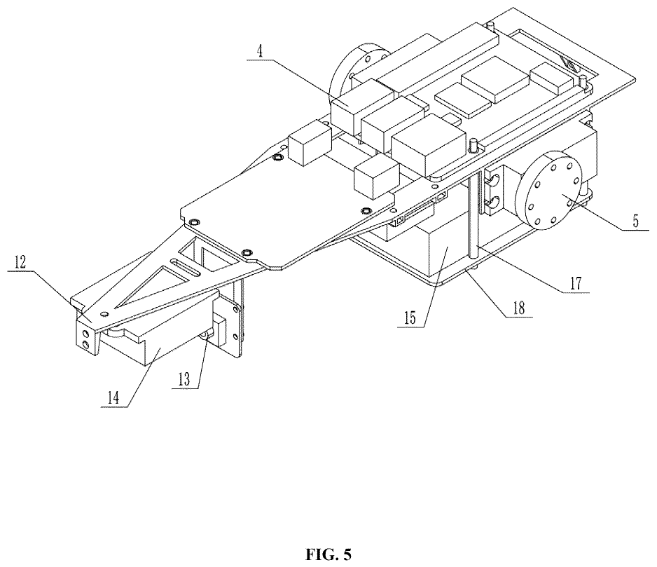

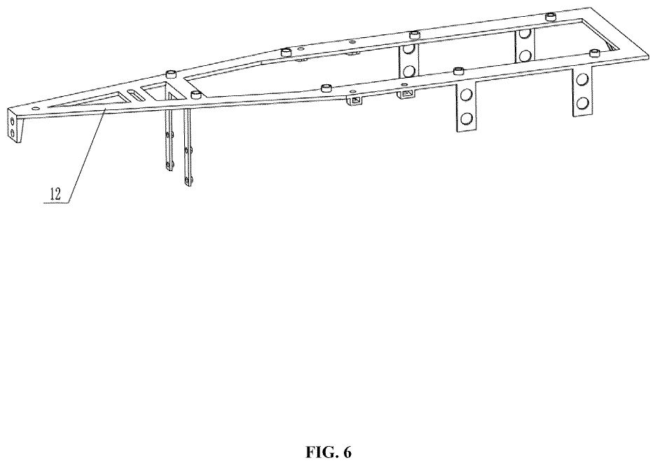

As shown in FIGS. 1 to 6, an embodiment provides a bionic sailfish, including a fish body 1, pectoral fins 2, a caudal fin 3 and a control module 4. The fish body 1 is of a streamlined structure, a cavity is formed in a interior of the fish body 1, and pectoral fin steering engines 5 are mounted on both sides of the interior of the cavity. If a coordinate system is made by taking a central point of the fish body 1 as an origin, X axis points to a front end of the fish body 1, Y axis points to a side of the fish body 1, and Z axis points to a back of the fish body 1. As an embodiment, rotation axes of output ends of the pectoral fin steering engines 5 are parallel to the Y axis and may also be located within an XY plane. In this embodiment, longitudinal sections of the pectoral fins 2 (sections obtained by cutting along a plane parallel to an XZ plane) are spindle-shaped, and the longitudinal sections on the pectoral fins 2 in any direction are parallel to a longitudinal central plane of the fish body 1. In other words, when the bionic sailfish advances, the pectoral fins 2 are arranged horizontally, and horizontal central planes of the pectoral fins 2 are located at or parallel to the XY plane. The pectoral fins 2 are located on both sides of the fish body 1, and the pectoral fins 2 are fixedly connected to the output ends of the pectoral fin steering engines 5. The caudal fin 3 is U-shaped, is arranged at a tail end of the fish body 1, and is connected to the fish body 1 through a fishtail steering engine. The control module 4 is arranged at the interior of the fish body 1 and electrically connected to the pectoral fin steering engines 5 and the steering engine.

When in use, the fishtail steering engine runs to drive a fishtail to swing, so as to provide forward power. The pectoral fin steering engines 5 can rotate to drive front ends of the pectoral fins 2 to swing upwards or downwards, so as to realize rising or diving, thereby a tank snorkeling system is omitted, the size of the bionic sailfish is greatly reduced, the running resistance of the bionic sailfish in water is less, and the movement is more flexible.

Front edges of the pectoral fins 2 are tilted backwards such that surface of water can be cut and forward resistance can be reduced. In a Y direction, dimensions of the longitudinal sections of the pectoral fins 2 decrease gradually.

In order to increase amplitude of movement of the caudal fin 3 and increase the forward power, in this embodiment, the bionic sailfish further includes a caudal peduncle 6 connected between the caudal fin 3 and the fish body 1, the caudal peduncle 6 is connected to the fish body 1 through a caudal peduncle steering engine 9 and connected to the caudal fin 3 through a caudal fin steering engine 8.

In this embodiment, the back of the fish body 1 is provided with a dorsal fin 7, and the dorsal fin 7 has a larger side area, such that movement stability of the bionic sailfish in water can be improved. As an embodiment, a front end surface of the dorsal fin 7 is gradually tilted upwards from front to back, the front end surface of the dorsal fin 7 is an arc surface that is concave-down in its middle portion, and an upper surface of the dorsal fin 7 is a plane gradually tilted upwards from front to back. The structure of the dorsal fin 7 may also be processed such that the dorsal fin does not have a distinct front end surface or upper end surface. At this time, both of a front end and a top end of the dorsal fin 7 take the shapes of sharp blades. A front edge and a upper edge of the dorsal fin are gradually tilted upwards from front to back, and the front edge is in the shape of an arc that is concave-down in its middle portion. The back of the fish body 1 is further provided with a wireless signal communication module 19 electrically connected to the control module 4, and the wireless signal communication module 19 is arranged behind the dorsal fin 7 for receiving and transmitting a contact signal between ground controllers. Specifically, the communication module 19 is secured to the back of the fish body 1 through bolt(s).

In this embodiment, the fish body 1 includes an upper housing 10 and a lower housing 11 connected through bolts, the upper housing 10 and the lower housing 11 are in substantially the same shape and have substantially the same internal volume, and the upper housing 10 and the lower housing 11 are connected through bolts. A keel 12 is connected to the upper housing 10 through bolts, and the keel 12 mainly plays roles of mounting the control module 4 and other electrical elements. The control module 4 is mounted above the keel 12.

In this embodiment, the control module 4 is configured to transmit control signals with the pectoral fin steering engines 5, the caudal fin steering engine 8, the caudal peduncle steering engine 9, a camera 13 and a gyroscope 14, The specific selection of a circuit board and the setting of a control program of the control module are well known to those skilled in the art, neither of which may be described in detail in this embodiment.

In this embodiment, a camera module is mounted at a bottom of a front end of the keel 12, the camera module is located in the lower housing 11, and the lower housing 11 is provided with a transparent window for the camera module to photograph therethrough. The camera module may include the camera 13 for taking underwater photos or taking underwater videos. The lower housing 11 may only be provided with a transparent window for the camera 13 to photograph, and the lower housing 11 may also be made of a transparent material as a whole.

In this embodiment, the gyroscope 14 is mounted at the front end of the keel 12, and is electrically connected to the control module 4. In this embodiment, the gyroscope 14 is located in front of the camera 13 for obtaining an angle of inclination of the fish body 1. A storage battery 15 is also mounted below the keel 12. The storage battery 15 is arranged on a bracket 18, and the bracket 18 is connected to the keel 12 through connecting rods 17.

As an embodiment, the front end of the fish body 1 is provided with a conical fish mouth 16 for imitating a protruding snout of a sailfish, which can further reduce the resistance to advancing of the bionic sailfish in water. After the upper housing 10 and the lower housing 11 are in threaded connection to form the complete fish body 1, the front end of the fish body 1 is provided with a threaded section for connecting the fish mouth 16.

In this embodiment, the fish body 1, the caudal peduncle 6, the caudal fin 3, the pectoral fins 2 and the dorsal fin 7 of the bionic sailfish may be all made through 3D printing, and a material adopted for 3D printing may be nylon carbon fiber or amorphous copolyester.

Adaptive changes made according to actual needs are all within the scope of protection of the present disclosure.

In the present disclosure, the principle and embodiments of the present disclosure are described herein by using specific examples, the above descriptions of the embodiments are merely intended to help understand the methods and core idea of the present disclosure. In addition, for those of ordinary skill in the art, changes may be made to the specific embodiments and the scope of application according to the concept of the present disclosure. In summary, the content of the description should not be construed as a limitation to the present disclosure.

What is claimed is:

1. A bionic sailfish, comprising:
a fish body mounted with pectoral fin steering engines at both sides of an interior of the fish body, and rotation axes of output ends of the pectoral fin steering engines extending along two sides of the fish body;
pectoral fins arranged on both sides of the fish body and fixedly connected to the output ends of the pectoral fin steering engines, longitudinal sections of the pectoral fins are spindle-shaped, and the longitudinal sections at any positions in the pectoral fins are parallel to a longitudinal central plane of the fish body;
a caudal fin arranged at a tail end of the fish body and connected to the fish body through a caudal fin steering engine; and
a control module arranged at the interior of the fish body and electrically connected to the pectoral fin steering engines and the caudal fin steering engine.

2. The bionic sailfish according to claim 1, wherein front edges of the pectoral fins are tilted backwards.

3. The bionic sailfish according to claim 1, further comprising a caudal peduncle connected between the caudal fin and the fish body through a caudal peduncle steering engine and the caudal fin steering engine, respectively.

4. The bionic sailfish according to claim 1, wherein a back of the fish body is provided with a dorsal fin.

5. The bionic sailfish according to claim 4, wherein the back of the fish body is provided with a wireless signal communication module electrically connected to the control module, the wireless signal communication module is arranged behind the dorsal fin.

6. The bionic sailfish according to claim 1, wherein the fish body comprises an upper housing and a lower housing connected through bolts, and a keel connected to the upper housing through bolts, the control module being mounted above the keel.

7. The bionic sailfish according to claim 6, further comprising a camera module mounted at a bottom of a front end of the keel, the camera module is located in the lower housing, and the lower housing is provided with a transparent window for the camera module to photograph therethrough.

8. The bionic sailfish according to claim 6, further comprising a storage battery further mounted below the keel, and a gyroscope mounted at a front end of the keel and is electrically connected to the control module.

9. The bionic sailfish according to claim 1, wherein a front end of the fish body is provided with a conical fish mouth.

10. The bionic sailfish according to claim 9, wherein the fish mouth is connected to the fish body through a thread.
